(19) United States
(12) Patent Application Publication
(10) Pub. No.: US 2023/0109319 A1
(43) Pub. Date: Apr. 6, 2023

(54) RECORDING MEDIUM AND EXTERIOR MEMBER

(71) Applicant: SONY GROUP CORPORATION, TOKYO (JP)

(72) Inventors: AYA TEJIMA, TOKYO (JP); KENICHI KURIHARA, TOKYO (JP); SATOKO ASAOKA, TOKYO (JP); ASUKA TEJIMA, TOKYO (JP)

(21) Appl. No.: 17/905,075

(22) PCT Filed: Mar. 2, 2021
(86) PCT No.: PCT/JP2021/007943

§ 371 Date: Aug. 26, 2022

(30) Foreign Application Priority Data
Mar. 4, 2020 (JP) 2020-037315

(51) Int. Cl. B41M 5/46; B41J 2/475

(52) U.S. Cl. CPC B41M 5/46; B41J 2/475

(57) ABSTRACT

A recording medium includes a recording layer configured to be able to change a color-developed state by an external stimulus and a plurality of structures provided on the recording layer. The recording layer has a plurality of color-developing portions, and a pitch Δd′ between the color-developing portions and a width W of each of the color-developing portions satisfy a relationship of Δd′>W.

### TECHNICAL FIELD

The present disclosure relates to a recording medium and an exterior member including the same.

### BACKGROUND ART

In recent years, as an example of display media that are replacing printed matters, a recording medium on which an image can be drawn by laser light irradiation has been developed. For example, in PTL 1, a recording medium in which a plurality of reversible heat-sensitive color-developable compositions having different color-developing tones are separately and independently provided in a plane direction of a support substrate, and the plurality of reversible heat-sensitive color-developable compositions contain light-heat conversion materials that absorb infrared rays in different wavelength ranges and generate heat is disclosed.

### CITATION LIST

### Patent Literature

[PTL 1]

JP 2004-188827 A

### SUMMARY

### Technical Problem

However, in the above recording medium, if a structure is provided on a surface, there is a problem that when an image is drawn by laser light irradiation, color density shift, color mixing, and the like occur, and display quality deteriorates.

An object of the present disclosure is to provide a recording medium capable of suppressing deterioration in display quality even in a case where a structure is provided on a surface and an exterior member including the same.

### Solution to Problem

In order to solve the above-described problems, a first disclosure is a recording medium including:
a recording layer configured to be able to change a color-developed state by an external stimulus; and
a plurality of structures provided on the recording layer,
wherein the recording layer has a plurality of color-developing portions, and
wherein a pitch Δd′ between the color-developing portions and a width W of each of the color-developing portions satisfy a relationship of Δd′>W.

A second disclosure is
a recording medium including:
a recording layer configured to be able to change a color-developed state by an external stimulus; and
a plurality of structures provided on the recording layer,
wherein the recording layer has a plurality of color-developing portions, and
wherein a pitch Δd′ between the color-developing portions changes in an in-plane direction of the recording layer.

A third disclosure is an exterior member including the recording medium of the first disclosure or the second disclosure.

### BRIEF DESCRIPTION OF DRAWINGS

FIG. 1 is a perspective view showing an example of a configuration of a recording medium according to a first embodiment.

FIG. 2A is a cross-sectional view along line IIA-IIA of FIG. 1. FIG. 2B is a cross-sectional view along line IIB-IIB of FIG. 1.

FIG. 3 is a schematic diagram for explaining a method of calculating a pitch Δd′_{X} between color-developing portions.

FIG. 4 is a perspective view showing an example of a configuration of a recording medium according to a second embodiment.

FIG. 5 is a cross-sectional view along line V-V of FIG. 4.

FIG. 6A is a perspective view showing an example of a configuration of a recording medium according to a third embodiment. FIG. 6B is a plan view showing the example of the configuration of the recording medium according to the third embodiment.

FIG. 7A is a cross-sectional view along line VIIA-VIIA of FIG. 6B. FIG. 7B is a cross-sectional view along line VIIB-VIIB of FIG. 6B.

FIG. 8A is a cross-sectional view showing an example of a configuration of a recording medium according to a fourth embodiment. FIG. 8B is a cross-sectional view showing a configuration of a recording layer as a reference example.

FIG. 9 is a cross-sectional view showing an example of a configuration of a recording medium according to a fifth embodiment.

FIGS. 10A to 10D are cross-sectional views each showing a configuration example of a recording medium according to a modification example.

FIGS. 11A to 11C are cross-sectional views each showing a configuration example of a recording medium according to a modification example.

FIGS. 12A to 12C are cross-sectional views each showing a configuration example of a recording medium according to a modification example.

FIG. 13A is a perspective view showing an external configuration of a front surface of a smartphone.

FIG. 13B is a perspective view showing an external configuration of a back surface of the smartphone shown in FIG. 13A.

FIG. 14 is a perspective view showing an example of an appearance of a nail tip.

FIG. 15A is a plan view showing an example of an appearance of a nail seal. FIG. 15B is a cross-sectional view along line XVB-XVB of FIG. 15A.

### DESCRIPTION OF EMBODIMENTS

The embodiments of the present disclosure will be described in the following order. In all the drawings of the following embodiments, the same or corresponding portions are designated by the same reference signs.

1 First Embodiment (an example of a recording medium in which a plurality of structures are one-dimensionally arranged on a surface)

2 Second Embodiment (an example of a recording medium in which a plurality of structures are one-dimensionally arranged on a surface)

3 Third Embodiment (an example of a recording medium in which a plurality of structures are two-dimensionally arranged on a surface)

4 Fourth Embodiment (an example of a recording medium on which multicolor display can be performed in a recording layer having a multiple layer structure)

5 Fifth Embodiment (an example of a recording medium on which multicolor display can be performed in a recording layer having a single layer structure)

6 Modification Example

7 Application Example

### 1 First Embodiment

### [Configuration of Recording Medium]

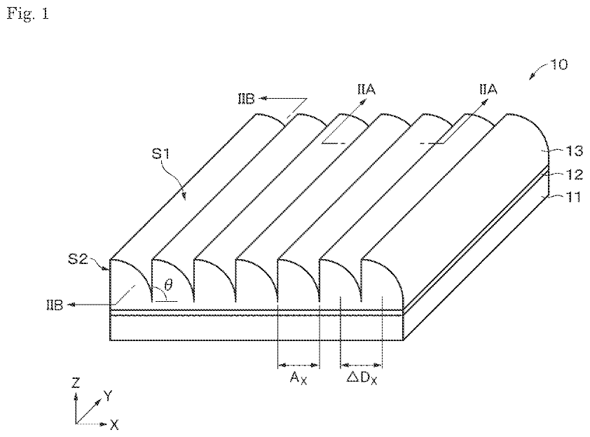

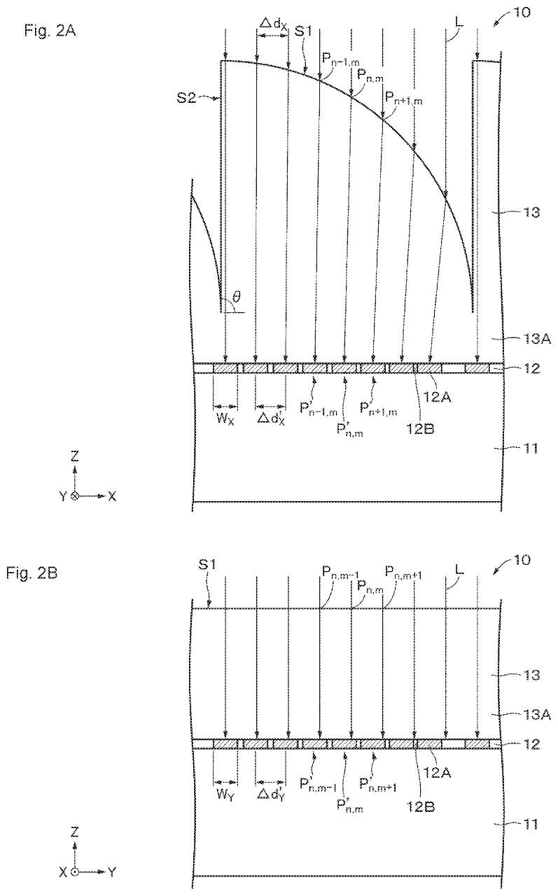

FIG. 1 is a perspective view showing an example of a configuration of a recording medium 10 according to a first embodiment. FIG. 2A is a cross-sectional view along line IIA-IIA of FIG. 1. FIG. 2B is a cross-sectional view along line IIB-IIB of FIG. 1. The recording medium 10 is a recording medium in which a color-developed state can be changed by an external stimulus such as irradiation with laser light or heat. The recording medium 10 may be a reversible recording medium or an irreversible recording medium. The recording medium 10 includes a support substrate 11, a recording layer 12 provided on the support substrate 11, and a plurality of structures 13 provided on the recording layer 12. The recording medium 10 may further include an intermediate layer 13A between the recording layer 12 and the plurality of structures 13. FIGS. 1A, 2A, and 2B schematically show the configuration of the recording medium 10 and may have dimensions and a shape different from the actual dimensions and shape.

In the present specification, axes orthogonal to each other in a plane of the recording layer 12 are referred to as an X axis and a Y axis, and an axis perpendicular to a surface of the recording layer 12 is referred to as a Z axis. Further, assuming that grid points are two-dimensionally disposed at intervals of a pitch dx in an X-axis direction and a pitch d_{Y} in a Y-axis direction, a position at an n-th grid point in the X-axis direction and an m-th grid point in the Y-axis direction is represented as P_{n, m}. A position on a surface of the structure 13 is represented using this position P_{n, m}.

### (Support Substrate)

The support substrate 11 is for supporting the recording layer 12. The support substrate 11 is preferably formed of a material having excellent heat resistance and excellent dimensional stability in a plane direction. The support substrate 11 may have either a light-transmitting property or a non-light-transmitting property. The support substrate 11 may have a specific color such as white. The support substrate 11 may be, for example, a rigid substrate such as a wafer, or flexible thin glass, a film, paper, or the like. A flexible (foldable) recording medium 10 can be realized using a flexible substrate as the support substrate 11. In FIGS. 1, 2A, and 2B, an example in which a main surface of the support substrate 11 is a flat surface is shown, but the main surface of the support substrate 11 may be a curved surface.

Examples of a constituent material of the support substrate 11 include an inorganic material, a metal material, a polymer material such as plastic, and the like. Specifically, examples of the inorganic material include silicon (Si), silicon oxide (SiO_{X}), silicon nitride (SiN_{X}), aluminum oxide (AlO_{X}), and the like. The silicon oxide includes glass, spin-on glass (SOG), and the like. Examples of the metal material include aluminum (Al), nickel (Ni), stainless steel and the like. Examples of the polymer material include polycarbonate (PC), polyethylene terephthalate (PET), polyethylene naphthalate (PEN), polyethyl ether ketone (PEEK), polyvinyl chloride (PVC), a copolymer thereof, and the like. The support substrate 11 may contain lame.

A reflective layer (not shown) may be provided on an upper surface or a lower surface of the support substrate 11, or the support substrate 11 itself may have a function as a reflective layer. When the support substrate 11 has such a configuration, more vivid color display becomes possible.

### (Recording Layer)

The recording layer 12 is configured such that the color-developed state can be changed by the external stimulus such as irradiation with laser light or heat. The recording layer 12 is formed of a material on which stable recording can be performed and a color-developed state can be controlled. Specifically, the recording layer 12 includes a color-exhibiting compound having an electron-donating property (an electron-donating dye) and an electron-accepting substance. The external stimulus (irradiation with laser light) causes a color-exhibiting reaction between the electron-donating dye and the electron-accepting substance, and an irradiated portion is color-developed. As a result, an image is formed on the recording layer 12. Here, the image includes not only images such as design patterns, color patterns, and photographs, but also text such as characters and symbols.

The recording layer 12 preferably further contains a photothermal conversion material or a polymer material, and more preferably further contains both of these materials. The recording layer 12 may contain various additives such as a sensitizer and an ultraviolet absorber in addition to the above-mentioned materials. A thickness of the recording layer 12 is, for example, 1 μm or more and 10 μm or less.

Examples of the color-exhibiting compound include a leuco dye. Examples of the leuco dye include existing dyes for thermal paper. Specifically, examples of the leuco dye include a compound represented by the following formula (1) and containing a group having an electron-donating property in a molecule.

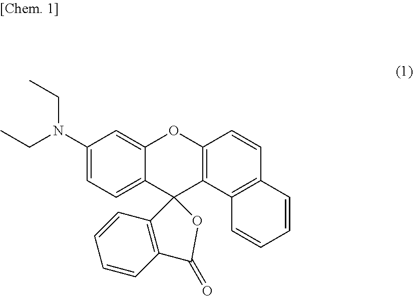 [SMILES: CCN(CC)c1ccc2c(c1)Oc1ccc3ccccc3c1C21OC(=O)c2ccccc21]

The color-exhibiting compound is not particularly limited and may be appropriately selected depending on the intended purpose. Specific examples of the color-exhibiting compound include a fluorane-based compound, a triphenylmethanephthalide-based compound, an azaphthalide-based compound, a phenothiazine-based compound, a leukooramine-based compound, indolinophthalide-based compounds, and the like in addition to the compound represented by the above formula (1). In addition, examples of the color-exhibiting compound include 2-anilino-3-methyl-6-diethylaminofluoran, 2-anilino-3-methyl-6-di(n-butylamino)fluoran, 2-anilino-3-methyl-6-(N-n-propyl-N-methylamino)fluoran, 2-anilino-3-methyl-6-(Nisopropyl-N-methylamino)fluoran, 2-anilino-3-methyl-6-(Nisobutyl-N-methylamino)fluoran, 2-anilino-3-methyl-6-(N-n-amyl-N-methylamino)fluoran, 2-anilino-3-methyl-6-(N-sec-butyl-N-methylamino)fluoran, 2-anilino-3-methyl-6-(N-n-amyl-N-ethylamino)fluoran, 2-anilino-3-methyl-6-(N-iso-amyl-N-ethylamino)fluoran, 2-anilino-3-methyl-6-(N-n-propyl-N-isopropylamino)fluoran, 2-anilino-3-methyl-6-(N-cyclohexyl-N-methylamino)fluoran, 2-anilino-3-methyl-6-(N-ethyl-p-toluidino)fluoran, 2-anilino-3-methyl-6-(N-methyl-p-toluidino)fluoran, 2-(m-trichloromethylanilino)-3-methyl-6-diethylaminofluoran, 2-(m-trifluoromethylanilino)-3-methyl-6-diethylaminofluoran, 2-(m-trichloromethylanilino)-3-methyl-6-(N-cyclohexyl-N-methylamino)fluorane, 2-(2,4-dimethylanilino)-3-methyl-6-diethylaminofluoran, 2-(N-ethyl-p-toluidino)-3-methyl-6-(N-ethylanilino)fluoran, 2-(N-ethyl-p-toluidino)-3-methyl-6-(N-propyl-p-toluidino)fluoran, 2-anilino-6-(N-n-hexyl-N-ethylamino)fluoran, 2-(o-chloroanilino)-6-diethylaminofluoran, 2-(o-chloroanilino)-6-dibutylaminofluoran, 2-(m-trifluoromethylanilino) diethylaminofluoran, 2,3-dimethyl-6-dimethylaminofluoran, 3-methyl-6-(N-ethyl-p-toluidino)fluoran, 2-chloro-6-diethylaminofluoran, 2-bromo diethylaminofluoran, 2-chloro-6-dipropylaminofluoran, 3-chloro cyclohexylaminofluoran, 3-bromo-6-cyclohexylaminofluoran, 2-chloro-6-(N-ethyl-N-isoamylamino)fluoran, 2-chloro-3-methyl-6-diethylaminofluoran, 2-anilino chloro-6-diethylaminofluoran, 2-(o-chloroanilino)-3-chloro cyclohexylaminofluoran, 2-(m-trifluoromethylanilino)-3-chloro diethylaminofluoran, 2-(2,3-dichloroanilino)-3-chloro-6-diethylaminofluoran, 1,2-benzo-6-diethylaminofluoran, 3-diethylamino-6-(m-trifluoromethylanilino)fluoran, 3-(1-ethyl-2-methylindol-3-yl)-3-(2-ethoxy-4-diethylaminophenyl)-4-azaphthalide, 3-(1-ethyl-2-methylindol-3-yl)-3-(2-ethoxy-4-diethylaminophenyl)-7-azaphthalide, 3-(1-octyl-2-methylindol-3-yl)-3-(2-ethoxy-4-diethylaminophenyl)-4-azaphthalide, 3-(1-ethyl-2-methylindol-3-yl)-3-(2-methyl-4-diethylaminophenyl)-4-azaphthalide, 3-(1-ethyl-2-methylindol-3-yl)-3-(2-methyl-4-diethylaminophenyl)-7-azaphthalide, 3-(1-ethyl-2-methylindol-3-yl)-3-(4-diethylaminophenyl)-4-azaphthalide, 3-(1-ethyl-2-methylindole-3-yl)-3-(4-N-n-amyl-N-methylaminophenyl)-4-azaphthalide, 3-(1-methyl-2-methylindol-3-yl)-3-(2-hexyloxy-4-diethylaminophenyl)-4-azaphthalide, 3,3-bis(2-ethoxy-4-diethylaminophenyl)-4-azaphthalide, 3,3-bis(2-ethoxy-4-diethylaminophenyl)-7-azaphthalide, 2-(p-acetylanilino)-6-(N-n-amyl-N-n-butylamino)fluoran, 2-benzylamino-6-(N-ethyl-p-toluidino)fluoran, 2-benzylamino-6-(N-methyl-2,4-dimethylanilino)fluoran, 2-benzylamino-6-(N-ethyl-2,4-dimethylanilino)fluoran, 2-benzylamino-6-(N-methyl-p-toluidino)fluoran, 2-benzylamino-6-(N-ethyl-p-toluidino)fluoran, 2-(di-p-methylbenzylamino)-6-(N-ethyl-p-toluidino)fluoran, 2-(α-phenylethylamino)-6-(N-ethyl-p-toluidino)fluoran, 2-methylamino-6-(N-methylanilino)fluoran, 2-methylamino-6-(N-ethylanilino)fluoran, 2-methylamino-6-(N-propylanilino)fluoran, 2-ethylamino-6-(N-methyl-p-toluidino)fluoran, 2-methylamino-6-(N-methyl-2,4-dimethylanilino)fluoran, 2-ethylamino-6-(N-ethyl-2,4-dimethylanilino)fluoran, 2-dimethylamino-6-(N-methylanilino)fluoran, 2-dimethylamino-6-(N-ethylanilino)fluoran, 2-diethylamino-6-(N-methyl-p-toluidino)fluoran, 2-diethylamino-6-(N-ethyl-p-toluidino)fluoran, 2-dipropylamino-6-(N-methylanilino)fluoran, 2-dipropylamino-6-(N-ethylanilino)fluoran, 2-amino-6-(N-methylanilino)fluoran, 2-amino-6-(N-ethylanilino)fluoran, 2-amino-6-(N-propylanilino)fluoran, 2-amino-6-(N-methyl-p-toluidino)fluoran, 2-amino-6-(N-ethyl-p-toluidino)fluoran, 2-amino-6-(N-propyl-p-toluidino)fluoran, 2-amino-6-(N-methyl-p-ethylanilino))fluoran, 2-amino-6-(N-ethyl-p-ethylanilino)fluoran, 2-amino-6-(N-propyl-p-ethylanilino)fluoran, 2-amino-6-(N-methyl-2,4-dimethylanilino)fluoran, 2-amino-6-(N-ethyl-2,4-dimethylanilino)fluoran, 2-amino-6-(N-propyl-2,4-dimethylanilino)fluoran, 2-amino-6-(N-methyl-p-chloroanilino)fluoran, 2-amino-6-(N-ethyl-p-chloroanilino)fluoran, 2-amino-6-(N-propyl-p-chloroanilino)fluoran, 1,2-benzo (N-ethyl-N-isoamylamino)fluoran, 1,2-benzo-6-dibutylaminofluoran, 1,2-benzo (N-methyl-N-cyclohexylamino))fluoran, 1,2-benzo-6-(N-ethyl-N-toluidino)fluoran, and the like.

The electron-accepting substance is a color-developing and color-reducing agent for the color-exhibiting compound. The electron-accepting substance is, for example, for color-developing the color-exhibiting compound in an achromatic state or decolorizing the color-exhibiting compound that exhibits a predetermined color. Examples of the color-developing and color-reducing agent include compounds having a salicylic acid backbone represented by the following formula (2) and containing a group having an electron-accepting property in a molecule.

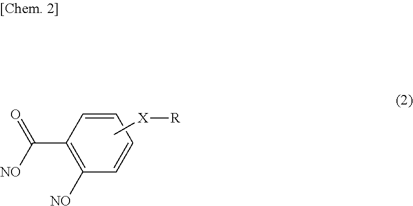

(Here, X is any one of —NHCO—, —CONH—, —NHCONH—, —CONHCO—, —NHNHCO—, —CONHNH—, —CONHNHCO—, —NHCOCONH—, —NHCONHCO—, —CONHCONH—, —NHNHCONH—, —NHCONHNH—, —CONHNHCONH—, —NHCONHNHCO—, and —CONHNHCONH—. R is a linear hydrocarbon group having 25 or more and 34 or less carbon atoms.)

The photothermal conversion material absorbs light in a predetermined wavelength region that is a near-infrared ray region and generates heat, for example. As the photothermal conversion material, for example, it is preferable to use a near-infrared ray absorbing dye having an absorption peak in a wavelength range of 700 nm or more and 2000 nm or less and having almost no absorption in a visible region. Specific examples of the photothermal conversion material include a compound having a phthalocyanine backbone (a phthalocyanine dye), a compound having a squarylium backbone (a squarylium dye), an inorganic compound, and the like. Examples of the inorganic compound include a metal complex such as a dithio complex, a diimonium salt, an aminium salt, an inorganic compound, and the like. Examples of the inorganic compound include graphite, carbon black, metal powder particles, metal oxides such as cobalt tetraoxide, iron oxide, chromium oxide, copper oxide, black titanium oxide, and indium tin oxide (ITO), metal nitrides such as niobide nitride, metal carbides such as tantalum carbide, metal sulfides, various magnetic powders, and the like. In addition, a compound having a cyanine backbone having excellent light resistance and heat resistance (a cyanine dye) may be used. Here, the excellent light resistance means that this compound is not decomposed when irradiated with laser light. The excellent heat resistance means that, for example, when a film is formed of this compound together with a polymer material and stored at 150° C. for 30 minutes, the maximum absorption peak value of an absorption spectrum does not change by 20% or more. Examples of the compound having such a cyanine backbone include a compound having at least one of a counter ion of any one of SbF₆, PF₆, BF₄, ClO₄, CF₃SO₃, and (CF₃SO₃)₂N, and a methine chain including a 5-membered ring or a 6-membered ring in a molecule. The compound having a cyanine backbone used in the recording medium 10 according to the first embodiment preferably has both of any one of the above counter ions and a cyclic structure such as a 5-membered ring and a 6-membered ring in the methine chain, but as long as the compound has at least one of them, sufficient light resistance and heat resistance are guaranteed.

The polymer material preferably has a function as a binder. The polymer material is preferably a material in which the color-exhibiting compound, the electron-accepting substance, and the photothermal conversion material are easily dispersed uniformly. Examples of the polymer material include at least one of a thermosetting resin and a thermoplastic resin. Specifically, examples of the polymer material include at least one selected from the group consisting of polyvinyl chloride, polyvinyl acetate, vinyl chloride-vinyl acetate copolymer, ethyl cellulose, polystyrene, styrene-based copolymer, phenoxy resin, polyester, aromatic polyester, polyurethane, polycarbonate, polyacrylic acid ester, polymethacrylic acid ester, acrylic acid-based copolymer, maleic acid-based polymer, polyvinyl alcohol, modified polyvinyl alcohol, hydroxyethyl cellulose, carboxymethyl cellulose, starch, and the like.

The recording layer 12 has a plurality of color-developing portions 12A and a plurality of non-color-developing portions 12B. Each of the color-developing portions 12A corresponds to a pixel for the image recorded on the recording layer 12. The plurality of color-developing portions 12A are disposed in a plane of the recording layer 12. An image is formed by the plurality of color-developing portions 12A. The color-developing portions 12A contain a color-exhibiting compound in a color-developed state.

The non-color-developing portions 12B are provided between the adjacent color-developing portions 12A. The non-color-developing portions 12B separate the adjacent color-developing portions 12A from each other and prevent the adjacent color-developing portions 12A from overlapping each other. The color-developing portions 12A contain a color-exhibiting compound in a decolorized state.

A pitch Δd′_{X} between the color-developing portions 12A in the X-axis direction and a width W_{X} of each of the color-developing portions 12A in the X-axis direction satisfy a relationship of Δd′_{X}>W_{X}. As a result, it is possible to prevent the color-developing portions 12A adjacent to each other in the X-axis direction from overlapping each other. Therefore, it is possible to prevent a color density from deviating from a desired color density at a portion where the color-developing portions 12A overlap each other in the X-axis direction.

A pitch Δd′_{Y} between the color-developing portions 12A in the Y-axis direction and a width W_{Y} of each of the color-developing portions 12A in the Y-axis direction satisfy a relationship of Δd′_{Y}>W_{Y}. As a result, it is possible to prevent the color-developing portions 12A adjacent to each other in the Y-axis direction from overlapping each other. Therefore, it is possible to prevent a color density from deviating from a desired color density at a portion where the color-developing portions 12A overlap each other in the Y-axis direction.

As shown in FIG. 2A, the pitch Δd′_{X} between the color-developing portions 12A in the X-axis direction changes in the X-axis direction (an in-plane direction of the recording layer 12). More specifically, in a case where light L incident on the position P_{n, m} on the surface of the structure 13 in a direction perpendicular to the recording layer 12 reaches a position P′_{n, m} of the color-developing portion 12A, the pitch Δd′_{X} between the color-developing portions 12A at the position P′_{n, m} becomes narrower as an inclination Δ_{X} of the surface of the structure 13 at the positions P_{n, m} becomes steeper. However, the position P_{n, m} indicates a position of the surface of the structure 13 in the in-plane direction of the recording layer 12. Further, the inclination α_{X} indicates an inclination of the surface of the structure 13 in the X-axis direction, that is, an inclination of the structure 13 in an XZ cross section.

As shown in FIG. 2B, the pitch Δd′_{Y} between the color-developing portions 12A in the Y-axis direction is constant in the Y-axis direction.

As described above, the pitch Δd′_{X} changes in the X-axis direction, and the pitch Δd′_{Y} is constant in the Y-axis direction. Therefore, when the image drawn on the recording layer 12 is viewed in a Z-axis direction through the structure 13, the image becomes an image without distortion in the X-axis direction (hereinafter referred to as a “regular image”). On the other hand, when the image drawn on the recording layer 12 in the Z-axis direction is viewed with the structure 13 removed, the image becomes an image distorted in the X-axis direction with respect to the regular image.

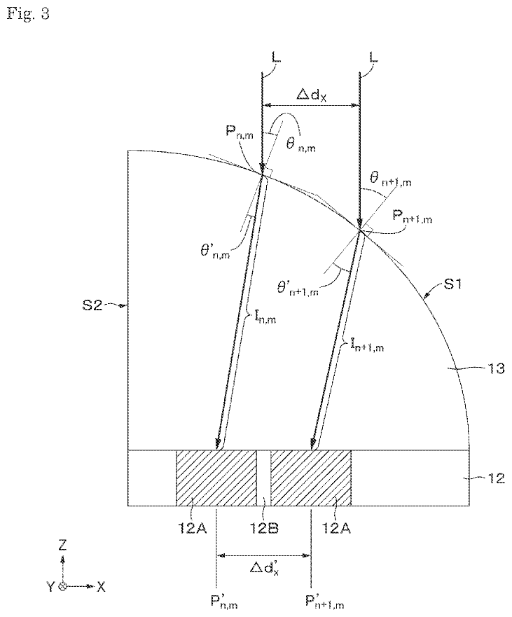

FIG. 3 is a schematic diagram for explaining a method of calculating the pitch Δd′_{X} between the color-developing portions 12A. The pitch Δd′_{X} between the color-developing portions 12A is obtained as follows. A relative refractive index n of the structure 13 with respect to air (a refractive index n₀=1), that is, a refractive index n of the structure 13, is expressed by the following equation (1) according to Snell's law.

n=sin θ_{n+1,m}/sin θ′_{n+1,m}=sin θ_{n,m}/sin θ′_{n,m} (1)

(Here, θ_{n, m}: an incidence angle of the laser light L incident on a position P_{n, m}, θ′_{n, m}: a refraction angle (an emission angle) of the laser light L incident on a position P_{n, m}, θ_{n+1, m}: an incidence angle of the laser light L incident on a position P_{n+1, m}, θ′_{n+1, m}: a refraction angle (an emission angle) of the laser light L incident on a position P_{n+1, m}, P_{n, m}: a position of a grid point which is an n-th position in the X-axis direction and an m-th position in the Y-axis direction, and P_{n+1, m}: a position of a grid point which is an n+1th position in the X-axis direction and an m-th position in the Y-axis direction)

The pitch Δd′_{X} between the color-developing portions 12A is expressed by the following equation (2a).

Δd′_{X}=Δd_{X}−(l_{n+1,m}·sin θ′_{n+1,m}−l_{n,m}·sin θ′_{n,m}) (2a)

(Here, l_{n+1, m}: a distance between positions P_{n+1, m}, P′_{n+1, m}, l_{n, m}: a distance between positions P_{n, m}, P′_{n, m}, Δd_{X}: a feed pitch of the laser light in the X-axis direction (a distance between a position P_{n, m} and a position P_{n+1, m}), P′_{n, m}: a position of the color-developing portion 12A which is an n-th position in the X-axis direction and an m-th position in the Y-axis direction, P′_{n+1, m}: a position of the color-developing portion 12A which is an n+1th position in the X-axis direction and an m-th position in the Y-axis direction)

The position of the color-developing portion 12A indicates the center position of the color-developing portion 12A.

When the formula (1) is used, sin θ′_{n+1, m} and sin θ′_{n, m} are sin θ′_{n+1, m}=sin θₙ₊₁/n and sin θ′_{n, m}=sin θₙ/n, respectively, and thus the above equation (2a) can be expressed as follows.

Δd′_{X}=Δd_{X}−(1/n)×(l_{n+1,m}·sin θ_{n+1,m}−l_{n,m}·sin θ_{n,m}) (2b)

### (Structure)

The structure 13 is a columnar body extending in the Y-axis direction (a first direction) such that a cross-sectional shape thereof is maintained. The plurality of structures 13 are one-dimensionally arranged in the X-axis direction (a second direction) such that column surfaces thereof face each other. The columnar surface of the columnar body is constituted by a first surface S1 and a second surface S2 extending in the Y-axis direction. A ridgeline is provided between the first surface S1 and the second surface S2. The first surface S1 is a convex curved surface such as an arch. The second surface S2 is a plane. This plane is substantially perpendicular to the surface of the recording layer 12. The angle θ formed by a bottom surface and the plane of the structure 13 is preferably 80 degrees or more and 100 degrees or less, and more preferably 85 degrees or more and 95 degrees or less. When the structure 13 is cut in the X-axis direction perpendicular to the Y-axis direction (that is, a ridgeline direction of the structure 13), the cut surface has substantially a fan shape.

The structure 13 preferably has transparency. The transparency is preferably transparency in a near infrared region and a visible region. Since the structure 13 has transparency in the near infrared region, an image can be drawn on the recording layer 12 using the laser light in the near infrared region. Further, since the structure 13 has transparency in the visible region, the image drawn on the recording layer 12 can be visually recognized. The refractive index of the structure 13 is preferably 1.35 or more and 1.85 or less, and more preferably 1.49 or more and 1.76 or less.

It is preferable that the pitch ≢DX between the structures 13 in the X-axis direction be sufficiently larger than the width W_{X} of each of the color-developing portions 12A in the X-axis direction from the viewpoint of the visibility of the structure 13 as a design and the ease of forming the structure 13. Specifically, a ratio (ΔD_{X}/W_{X}) of the pitch ΔD_{X} between the structures 13 in the X-axis direction to the width W_{X} of each of the color-developing portions 12A in the X-axis direction is preferably 1 or more and 10000 or less, and more preferably 100 or more and 1000 or less.

It is preferable that the pitch ΔD_{X} between the structures 13 in the X-axis direction be sufficiently larger than the pitch Δd′_{X} between the color-developing portions 12A in the X-axis direction from the viewpoint of the visibility of the structure 13 as a design and the ease of forming the structure 13. Specifically, a ratio (ΔD_{X}/Δd′_{X}) of the pitch ΔD_{X} between the structures 13 in the X-axis direction to the pitch Δd′_{X} between the color-developing portions 12A in the X-axis direction is preferably 0.5 or more and 1000 or less, and more preferably 0.8 or more and 900 or less.

It is preferable that a width A_{X} of each of the structures 13 in the X-axis direction be sufficiently larger than the width W_{X} of each of the color-developing portions 12A in the X-axis direction from the viewpoint of the visibility of the structure 13 as a design and the ease of forming the structure 13. Specifically, a ratio (A_{X}/W_{X}) of the width A_{X} of each of the structures 13 in the X-axis direction to the width W_{X} of each of the color-developing portions 12A in the X-axis direction is preferably 1 or more and 10000 or less, and more preferably 100 or more and 1000 or less.

The width W_{X} of each of the color-developing portions 12A in the X-axis direction is preferably 10 μm or more and 100 μm or less from the viewpoint of improving a resolution. The pitch Δd′_{X} between the color-developing portions 12A in the X-axis direction is preferably 10 μm or more and 100 μm or less from the viewpoint of improving a resolution. The pitch ΔD_{X} between the structures 13 in the X-axis direction is preferably 0.1 mm or more and 10000 mm or less, and more preferably 1 mm or more and 10000 mm or less. The width Δ_{X} of each of the structures 13 in the X-axis direction is preferably 0.1 mm or more and 10000 mm or less, and more preferably 1 mm or more and 10000 mm or less.

Assuming that the maximum value of a distance l between the position P_{n, m} on the surface of the structure 13 and the color-developing portion 12A is lₘₐₓ, it is preferable that lₘₐₓ be sufficiently larger than a wavelength of visible light from the viewpoint of the visibility of the structure 13 as a design and the ease of forming the structure 13. Specifically, lₘₐₓ is preferably 0.1 mm or more and 10000 mm or less, and more preferably 1 mm or more and 1000 mm or less. Assuming that the minimum value of the distance l between the position P_{n, m} on the surface of the structure 13 and the color-developing portion 12A is lₘᵢₙ, a difference between lₘₐₓ and lₘᵢₙ (lₘₐₓ−lₘᵢₙ) is, for example, 0.1 mm or more and 10000 mm or less.

The structure 13 includes, for example, a polymer resin, glass, or a complex thereof. As the polymer resin, for example, at least one resin material among a thermoplastic resin, a thermosetting resin, and an ultraviolet curable resin can be used. Specific examples of the polymer resin include at least one selected from the group consisting of triacetyl cellulose (TAC), polyester (TPEE), polyethylene terephthalate (PET), polyethylene naphthalate (PEN), polyimide (PI), polyamide (PA), aramid, polyethylene (PE), polyacrylate, polyether sulphon, polysulphon, polypropylene (PP), diacetyl cellulose, polyvinyl chloride, acrylic resin (PMMA), polycarbonate (PC), epoxy resin, urea resin, urethane resin, melamine resin, cycloolefin polymer (COP), and the like. Examples of the glass include at least one selected from the group consisting of quartz, sapphire, glass, and the like.

### (Intermediate Layer)

The intermediate layer 13A is provided between the plurality of structures 13 and the recording layer 12. The intermediate layer 13A may be integrally formed with the structure 13 on the bottom side of the structure 13. The intermediate layer 13A preferably has transparency. The transparency is preferably transparency in a near infrared region and a visible region. The intermediate layer 13A may be formed of the same material as the structure 13, or may be formed of a material different from that of the structure 13.

### [Manufacturing Method of Recording Medium]

The recording medium 10 according to the first embodiment can be manufactured, for example, using an application method. The manufacturing method described below is an example, and other methods may be used for manufacturing.

First, the polymer material is dissolved in a solvent (for example, methyl ethyl ketone). Next, a color-exhibiting compound, an electron-accepting substance, and a photothermal conversion material are added to this solution and dispersed in this solution. As a result, an application material for forming a recording layer is obtained. Subsequently, this application material for forming a recording layer is applied onto the support substrate 11 to a thickness of, for example, 3 μm, and dried at, for example, 70° C. to form the recording layer 12. Next, the resin is applied onto the recording layer 12, and the resin is cured while a mold is pressed against the resin to form the plurality of structures 13. As a result, the recording medium 10 shown in FIG. 1 is obtained.

The recording layer 12 may be formed using a method other than the above application. For example, a layer previously formed by being applied to a separate substrate may be attached onto the support substrate 11 via, for example, an adhesion layer to form the recording layer 12. Alternatively, the support substrate 11 may be immersed in the application material to form the recording layer 12.

### [Method of Setting Drawing Parameter]

When a portion where a difference Δθ′=|θ′_{n+1, m}−θ′_{n, m}| between the refraction angles θ′_{n, m}, θ′_{n+1, m} at the positions P_{n, m}, P_{n+1, m} is the largest is drawn on, the color-developing portions 12A adjacent to each other in the X-axis direction are likely to overlap each other. Therefore, if the relationship of Δd′_{X}>W_{X} is satisfied in the portion where the difference Δθ′ between the refraction angles θ′_{n, m}, θ′_{n+1, m} is the largest, the relationship of Δd′_{X}>W_{X} can be satisfied in other portions as well. Therefore, if the parameters at the time of drawing are set to satisfy the relationship of Δd′_{X}>W_{X} in the portion where the difference Δθ′ between the refraction angles θ′_{n, m}, θ′_{n+1, m} is the largest, an image can be drawn to satisfy the relationship of Δd′_{X}>W_{X}.

Specifically, the parameters at the time of drawing are set as follows. First, detailed shape information on the entire structure 13 is acquired using a 3D scanning device or the like. Next, a position where the difference Δθ′=|θ′_{n+1, m}−θ′_{n, m}| between the refraction angles θ′_{n, m}, θ′_{n+1, m} is the largest is specified on the first surface (the curved surface) S1 of the structure 13 using the acquired shape information.

Next, the distance l and the incidence angles θ_{n+1, m}, θ_{n, m} at the specific position are obtained using the acquired shape information. Next, the refractive index n of the structure 13 is used to be obtained using, for example, an Abbe refractive index meter or the like. A constituent material of the structure 13 may be specified by instrumental analysis or the like, and a typical refractive index n of the constituent material may be used. Here, the refractive index is a refractive index with respect to the laser light L used for drawing.

Next, the value of Δd_{X} is obtained from the equation (2b) using the distance l, the incidence angles θ_{n+1, m}, θ_{n, m}, and the refractive index n obtained as described above such that the relationship of Δd′_{X}>W_{X} is satisfied at the specific position. The width W_{X} of each of the color-developing portions 12A is set to a predetermined value (for example, 50 μm) depending on a spot diameter of the laser light L. Further, the width W_{X} of each of the color-developing portions 12A is substantially constant regardless of the position in the X-axis direction.

### [Drawing Method]

In the recording medium 10 according to the first embodiment, for example, an image can be drawn on the recording layer 12 via the structure 13 as follows.

First, the recording layer 12 is heated at a temperature at which the color-exhibiting compound is decolorized, for example, 120° C., to be in a decolorized state in advance. Next, near-infrared rays (the external stimulus) of which a wavelength and an output are adjusted are radiated to a desired position of the recording layer 12 via the structure 13 from, for example, a semiconductor laser. As a result, the photothermal conversion material contained in the recording layer 12 generates heat, a color-exhibiting reaction (a color-developing reaction) occurs between the color-exhibiting compound and the electron-accepting substance, the irradiated portion is color-developed, and the color-developing portion 12A is formed.

On the other hand, in a case where the color-developed portion is to be decolorized, near-infrared rays are radiated through the structure 13 with energy sufficient to reach a decolorization temperature. As a result, the photothermal conversion material contained in the recording layer 12 generates heat, a decolorizing reaction occurs between the color-exhibiting compound and the electron-accepting substance, the color development of the irradiated portion disappears, and the recording is erased. Further, in a case where all the recordings formed on the recording layer 12 are erased at once, the recording medium 10 is heated at a temperature sufficient for decolorization, for example, 120° C. As a result, the information recorded on the recording layer 12 is erased all at once. After that, by performing the above-mentioned operation, it is possible to repeat the recording on the recording layer 12.

The color-developed state and the decolorized state are maintained unless the color-developing reaction and the decolorizing reaction such as the radiation of the near-infrared rays and the heating described above are performed.

### [Operational Effect]

In the recording medium 10 according to the first embodiment, the pitch Δd′_{X} between the color-developing portions 12A in the X-axis direction and the width W_{X} of each of the color-developing portions 12A in the X-axis direction satisfy the relationship of Δd′_{X}>W_{X}. As a result, even if the first surface S1 of the structure 13 is a convex curved surface such as an arch, it is possible to prevent the color-developing portions 12A adjacent to each other in the X-axis direction from overlapping each other. Therefore, even if the first surface S1 of the structure 13 is a convex curved surface such as an arch, it is possible to prevent a color density from deviating from a desired color density.

Further, since the structure 13, that is, the unevenness, is provided on the surface of the recording medium 10, it is possible to improve the design of an exterior member, an electronic device, or the like to which the recording medium 10 is applied. In addition, the surface of the exterior member or the electronic device to which the recording medium 10 is applied becomes less slippery. Further, since the recording layer 12 can be drawn on by irradiating the surface of the structure 13 with the laser light, it is not necessary to perform a process of distorting a regular image. Further, since it is not necessary to align the plurality of structures 13 with the recording layer 12 after the drawing, the recording medium 10 can be easily manufactured.

### 2 Second Embodiment

### [Configuration of Recording Medium]

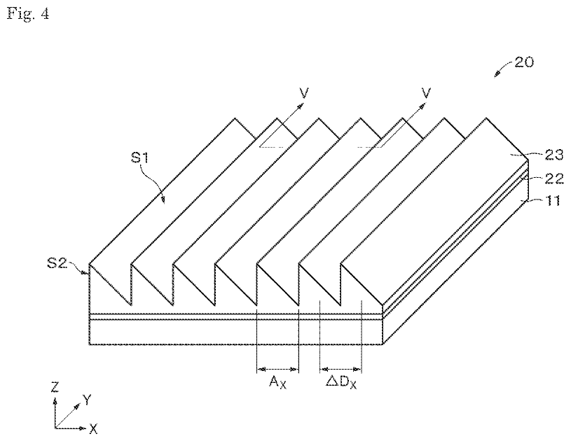

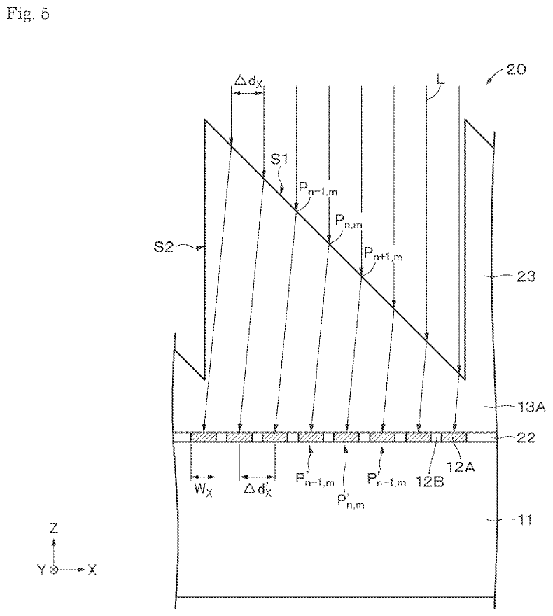

FIG. 4 is a perspective view showing an example of a configuration of a recording medium 20 according to a second embodiment. FIG. 5 is a cross-sectional view along line V-V of FIG. 4. The recording medium 20 is different from the recording medium 10 according to the first embodiment in that a recording layer 22 and a structure 23 are provided instead of the recording layer 12 and the structure 13 (see FIGS. 1, 2A, and 2B).

### (Recording Layer)

The recording layer 22 is different from the recording layer 12 of the first embodiment in that the pitch Δd′_{X} between the color-developing portions 12A in the X-axis direction is constant in the X-axis direction except for a boundary portion between the adjacent structures 23.

### (Structure)

The structure 23 is different from the structure 13 of the first embodiment in that the first surface S1 is a plane inclined with respect to the surface of the recording layer 12. When the structure 13 is cut in the X-axis direction perpendicular to the Y-axis direction (that is, a ridgeline direction of the structure 13), the cut surface has a substantially right triangular shape.

FIG. 4 shows an example in which the first surface S1 and the second surface S2 face each other between the adjacent structures 13, but the orientations of the first surface S1 and the second surface S2 are not limited to this. For example, the first surfaces S1 may face each other or the second surfaces S2 may face each other between the adjacent structures 13.

### [Operational Effect]

In the recording medium 20 according to the second embodiment, the pitch Δd′_{X} between the color-developing portions 12A is constant except for the boundary portion between the adjacent structures 23, and thus the display quality of the image can be improved.

### 3 Third Embodiment

### [Configuration of Recording Medium]

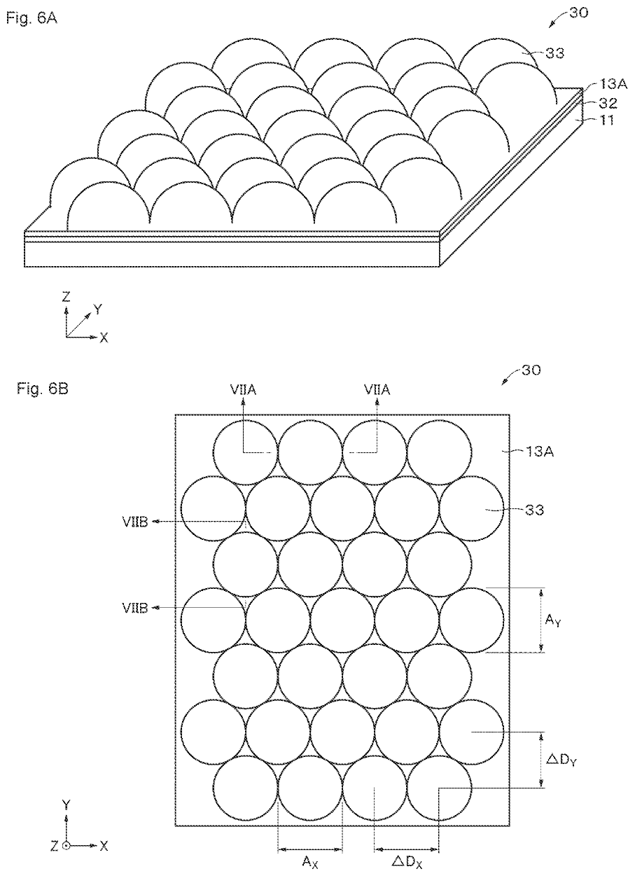

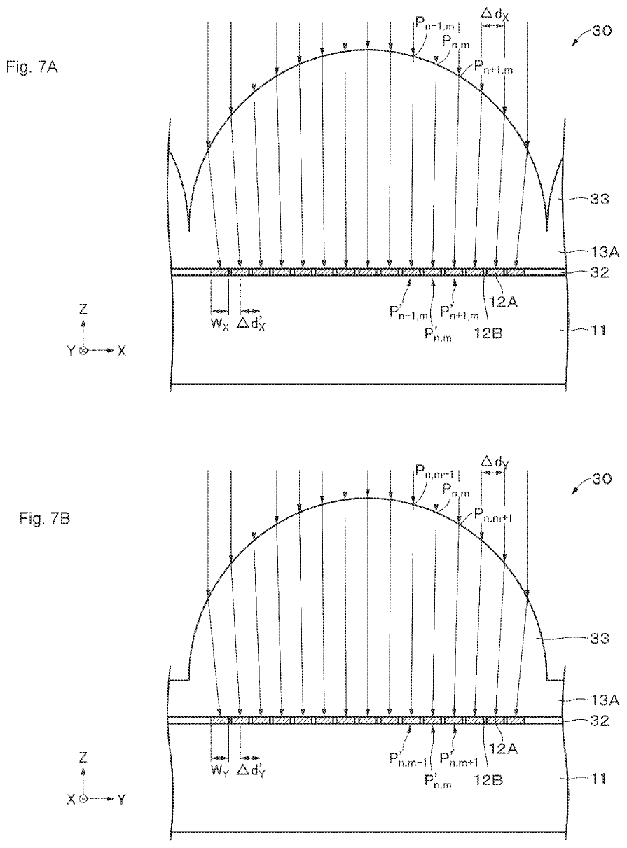

FIG. 6A is a perspective view showing an example of a configuration of a recording medium 30 according to a third embodiment. FIG. 6B is a plan view showing the example of the configuration of the recording medium 20 according to the third embodiment. FIG. 7A is a cross-sectional view along line VIIA-VIIA of FIG. 6B. FIG. 7B is a cross-sectional view along line VIIB-VIIB of FIG. 6B. The recording medium 30 is different from the recording medium 10 according to the first embodiment in that a recording layer 32 and a structure 33 are provided instead of the recording layer 12 and the structure 13 (see FIGS. 1, 2A, and 2B).

### (Recording Layer)

A pitch Δd′_{X} between the color-developing portions 12A in the X-axis direction and a width W_{X} of each of the color-developing portions 12A in the X-axis direction satisfy a relationship of Δd′_{X}>W_{X}. As a result, it is possible to prevent the color-developing portions 12A adjacent to each other in the X-axis direction from overlapping each other. Therefore, it is possible to prevent a color density from deviating from a desired color density at a portion where the color-developing portions 12A overlap each other in the X-axis direction.

A pitch Δd′_{Y} between the color-developing portions 12A in the Y-axis direction and a width W_{Y} of each of the color-developing portions 12A in the Y-axis direction satisfy a relationship of Δd′_{Y}>W_{Y}. As a result, it is possible to prevent the color-developing portions 12A adjacent to each other in the Y-axis direction from overlapping each other. Therefore, it is possible to prevent a color density from deviating from a desired color density at a portion where the color-developing portions 12A overlap each other in the Y-axis direction.

As shown in FIG. 7A, the pitch Δd′_{X} between the color-developing portions 12A in the X-axis direction changes in the X-axis direction (an in-plane direction of the recording layer 32). More specifically, in a case where light L incident on the position P_{n, m} on the surface of the structure 33 in a direction perpendicular to the recording layer 32 reaches a position P′_{n, m} of the color-developing portion 12A, the pitch Δd′_{X} between the color-developing portions 12A at the position P′_{n, m} becomes narrower as an inclination α_{X} of the surface of the structure 33 at the positions P_{n, m} becomes steeper. However, the position P_{n, m} indicates a position of the surface of the structure 33 in the in-plane direction of the recording layer 32. Further, the inclination α_{X} indicates an inclination in the X-axis direction, that is, an inclination of the structure 33 in an XZ cross section.

As shown in FIG. 7B, the pitch Δd′_{Y} between the color-developing portions 12A in the Y-axis direction changes in the Y-axis direction (an in-plane direction of the recording layer 32). More specifically, in a case where light L incident on the position P_{n, m} on the surface of the structure 33 in a direction perpendicular to the recording layer 32 reaches a position P′_{n, m} of the color-developing portion 12A, the pitch Δd′_{Y} between the color-developing portions 12A at the position P′_{n, m} becomes narrower as an inclination α_{Y} of the surface of the structure 33 at the positions P_{n, m} becomes steeper. Here, the inclination α_{Y} indicates an inclination in the Y-axis direction, that is, an inclination of the structure 33 in an YZ cross section.

As described above, the pitch Δd′_{X} changes in the X-axis direction, and the pitch Δd′_{Y} changes in the Y-axis direction. Therefore, when the image drawn on the recording layer 32 is viewed in a Z-axis direction through the structure 13, the image becomes an image without distortion in the X-axis direction and the Y-axis direction (hereinafter referred to as a “regular image”). On the other hand, when the image drawn on the recording layer 32 in the Z-axis direction is viewed with the structure 13 removed, the image becomes an image distorted in the X-axis direction and the Y-axis direction with respect to the regular image.

The recording layer 32 is the same as the recording layer 12 of the first embodiment except for the above.

### (Structure)

The structures 33 are two-dimensionally arranged in a regular predetermined arrangement pattern. The plurality of structures 21 are arranged to form a plurality of rows on the surface of the support substrate 11, for example. The surface of the structure 21 is a convex curved surface that curves in both the X-axis direction and the Y-axis direction. The structure 21 has, for example, a substantially hemispherical shape.

It is preferable that the pitch ΔD_{X} between the structures 33 in the X-axis direction be sufficiently larger than the width W_{X} of each of the color-developing portions 12A in the X-axis direction from the viewpoint of the visibility of the structure 33 as a design and the ease of forming the structure 33. Specifically, a ratio (ΔD_{X}/W_{X}) of the pitch ΔD_{X} between the structures 33 in the X-axis direction to the width W_{X} of each of the color-developing portions 12A in the X-axis direction is preferably 1 or more and 10000 or less, and more preferably 100 or more and 1000 or less.

It is preferable that the pitch ΔD_{Y} between the structures 33 in the Y-axis direction be sufficiently larger than the width W_{Y} of each of the color-developing portions 12A in the Y-axis direction from the viewpoint of the visibility of the structure 33 as a design and the ease of forming the structure 33. Specifically, a ratio (ΔD_{Y}/W_{Y}) of the pitch ΔD_{Y} between the structures 33 in the Y-axis direction to the width W_{Y} of each of the color-developing portions 12A in the Y-axis direction is preferably 1 or more and 10000 or less, and more preferably 100 or more and 1000 or less.

It is preferable that the pitch ΔD_{X} between the structures 33 in the X-axis direction be sufficiently larger than the pitch Δd′_{X} between the color-developing portions 12A in the X-axis direction from the viewpoint of the visibility of the structure 33 as a design and the ease of forming the structure 33. Specifically, a ratio (ΔD_{X}/Δd′_{X}) of the pitch ΔD_{X} between the structures 33 in the X-axis direction to the pitch Δd′_{X} between the color-developing portions 12A in the X-axis direction is preferably 0.5 or more and 1000 or less, and more preferably 0.8 or more and 900 or less.

It is preferable that the pitch ΔD_{Y} between the structures 33 in the Y-axis direction be sufficiently larger than the pitch Δd′_{Y} between the color-developing portions 12A in the Y-axis direction from the viewpoint of the visibility of the structure 33 as a design and the ease of forming the structure 33. Specifically, a ratio (ΔD_{Y}/Δd′_{Y}) of the pitch ΔD_{Y} between the structures 33 in the Y-axis direction to the pitch Δd′_{Y} between the color-developing portions 12A in the Y-axis direction is preferably 0.5 or more and 1000 or less, and more preferably 0.8 or more and 900 or less.

It is preferable that a width A_{X} of each of the structures 33 in the X-axis direction be sufficiently larger than the width W_{X} of each of the color-developing portions 12A in the X-axis direction from the viewpoint of the visibility of the structure 33 as a design and the ease of forming the structure 33. Specifically, a ratio (A_{X}/W_{X}) of the width A_{X} of each of the structures 33 in the X-axis direction to the width W_{X} of each of the color-developing portions 12A in the X-axis direction is preferably 1 or more and 10000 or less, and more preferably 100 or more and 1000 or less.

It is preferable that the width A_{Y} of each of the structures 33 in the Y-axis direction be sufficiently larger than the width W_{Y} of each of the color-developing portions 12A in the Y-axis direction from the viewpoint of the visibility of the structure 33 as a design and the ease of forming the structure 33. Specifically, a ratio (A_{Y}/W_{Y}) of the width A_{Y} of each of the structures 33 in the Y-axis direction to the width W_{Y} of each of the color-developing portions 12A in the Y-axis direction is preferably 1 or more and 10000 or less, and more preferably 100 or more and 1000 or less.

The width W_{X} of each of the color-developing portions 12A in the X-axis direction is preferably 10 μm or more and 100 μm or less from the viewpoint of improving a resolution. The pitch Δd′_{X} between the color-developing portions 12A in the X-axis direction is preferably 10 μm or more and 100 μm or less from the viewpoint of improving a color density. The pitch ΔD_{X} between the structures 33 in the X-axis direction is preferably 0.1 mm or more and 10000 mm or less, and more preferably 1 mm or more and 1000 mm or less. The width A_{X} of each of the structures 33 in the X-axis direction is preferably 0.1 mm or more and 10000 mm or less, and more preferably 1 mm or more and 1000 mm or less.

The width W_{Y} of each of the color-developing portions 12A in the Y-axis direction is preferably 10 μm or more and 100 μm or less from the viewpoint of improving a resolution. The pitch Δd′_{X} between the color-developing portions 12A in the Y-axis direction is preferably 10 μm or more and 100 μm or less from the viewpoint of improving a color density. The pitch ΔD_{Y} between the structures 33 in the Y-axis direction is preferably 0.1 mm or more and 10000 mm or less, and more preferably 1 mm or more and 1000 mm or less. The width A_{Y} of each of the structures 33 in the Y-axis direction is preferably 0.1 mm or more and 10000 mm or less, and more preferably 1 mm or more and 1000 mm or less.

The structure 33 is the same as the structure 13 of the first embodiment except for the above.

### [Operational Effect]

In the recording medium 30 according to the third embodiment, the pitch Δd′_{X} between the color-developing portions 12A in the X-axis direction and the width W_{X} of each of the color-developing portions 12A in the X-axis direction satisfy the relationship of Δd′_{X}>W_{X}, and the pitch Δd′_{Y} between the color-developing portions 12A in the Y-axis direction and the width W_{Y} of each of the color-developing portions 12A in the Y-axis direction satisfy the relationship of Δd′_{Y}>W_{Y}. As a result, even in a case where the structure 13 has a curved surface shape such as a substantially hemispherical shape, it is possible to prevent the color-developing portions 12A adjacent to each other in the X-axis direction and the color-developing portions 12A adjacent to each other in the Y-axis direction from overlapping each other. Therefore, even in a case where the structure 13 has a curved surface shape such as a substantially hemispherical shape, it is possible to prevent a color density from deviating from a desired color density.

### 4 Fourth Embodiment

### [Configuration of Recording Medium]

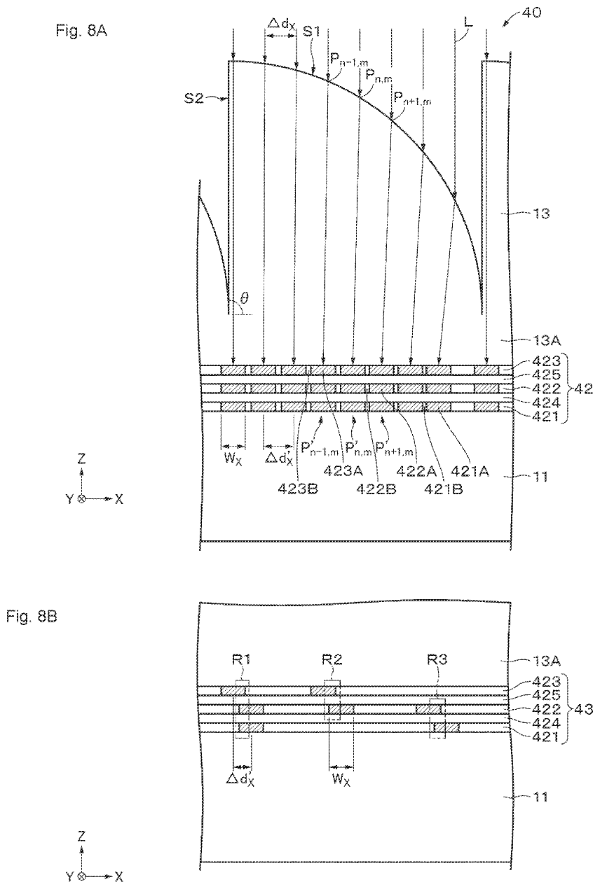

FIG. 8A is a cross-sectional view showing an example of a configuration of a recording medium 40 according to a fourth embodiment. The recording medium 40 is different from the recording medium 10 according to the first embodiment in that it includes a multi-layered recording layer 42 that displays a multicolor (for example, full color) image instead of the recording layer 12 having a single layer structure (see FIGS. 1, 2A, 2B) that displays a single color image.

The recording layer 42 includes a first layer 421, a second layer 422, a third layer 423, a heat insulating layer 424, and a heat insulating layer 425. The second layer 422 is provided on the first layer 421, and the third layer 423 is provided on the second layer 422. The heat insulating layer 424 is provided between the first layer 421 and the second layer 422, and a heat insulating layer 425 is provided between the second layer 422 and the third layer 423.

The first layer 421, the second layer 422, and the third layer 423 contain dyes exhibiting different colors, and an image is formed by the dyes contained in these layers. The first layer 421 contains, for example, a dye that develops a yellow color. The second layer 422 contains, for example, a dye that develops a cyan color. The third layer 423 contains, for example, a dye that develops a magenta color.

The first layer 421 has, for example, a color-developing portion 421A containing a dye in a color-developed state and a non-color-developing portion 421B containing color development in a decolorized state. The second layer 422 has, for example, a color-developing portion 422A containing a dye in a color-developed state and a non-color-developing portion 422B containing color development in a decolorized state. The third layer 423 has, for example, a color-developing portion 423A containing a dye in a color-developed state and a non-color-developing portion 423B containing color development in a decolorized state. The non-color-developing portion 421B, the non-color-developing portion 422B, and the non-color-developing portion 423B have, for example, transparency.

FIG. 8A shows an example in which the color-developing portion 421A, the color-developing portion 422A, and the color-developing portion 423A are arranged to overlap each other at all positions P′_{n, m}, but the arrangement of the color-developing portion 421A, the color-developing portion 422A, and the color-developing portion 423A is selected according to the image to be drawn on the recording layer 42 and is not limited to the arrangement example shown in FIG. 8A.

It is preferable that the first layer 421, the second layer 422, and the third layer 423 be each formed of a material on which stable recording can be performed and a color-developed state can be controlled. Specifically, the first layer 421, the second layer 422, and the third layer 423 contain, for example, color-exhibiting compounds having different color-developing hues and electron-accepting substances corresponding to the color-exhibiting compounds. The first layer 421, the second layer 422, and the third layer 423 preferably contain photothermal conversion materials that absorb light rays in different wavelength ranges and generate heat or polymer resins, and more preferably contain both of these materials.

As described above, the electron-accepting substance is, for example, for color-developing the color-exhibiting compound in an achromatic state or color-reducing the color-exhibiting compound that exhibits a predetermined color. The electron-accepting substance is selected from, for example, compounds having a salicylic acid backbone represented by the following formula (2) and containing a group having an electron accepting property in a molecule. The photothermal conversion material is selected from, for example, a compound having a phthalocyanine backbone (a phthalocyanine dye), a compound having a squarylium backbone (a squarylium dye), an inorganic compound, and the like, as described above. In addition, as in the first embodiment, a compound having a cyanine backbone having excellent light resistance and heat resistance (a cyanine dye) may be used.

Specifically, the first layer 421 contains, for example, a color-exhibiting compound that develops a yellow color in a color-developed state, an electron-accepting substance corresponding thereto, a photothermal conversion material that absorbs infrared rays having a wavelength of λ₁ and generates heat, and a polymer resin. The second layer 422 contains, for example, a color-exhibiting compound that exhibits a cyan color in a color-developed state, an electron-accepting substance corresponding thereto, a photothermal conversion material that absorbs infrared rays having a wavelength of λ₂ and generates heat, and a polymer resin. The third layer 423 contains, for example, a color-exhibiting compound that exhibits a magenta color in a color-developed state, an electron-accepting substance corresponding thereto, a photothermal conversion material that absorbs infrared rays having a wavelength of λ₃ and generates heat, and a polymer resin. As a result, a recording layer 42 on which multicolor display can be performed can be obtained.

As the photothermal conversion material, a combination of materials having a narrow light absorption band, for example, in a wavelength range of 700 nm or more and 2000 nm or less and not overlapping each other is preferably selected. As a result, it is possible to selectively develop or reduce the color of a desired layer among the first layer 421, the second layer 422, and the third layer 423.

The thickness of each of the first layer 421, the second layer 422, and the third layer 423 is preferably, for example, 1 μm or more and 20 μm or less, and more preferably 2 μm or more and 15 μm or less. If the thickness of each of the first layer 421, the second layer 422, and the third layer 423 is less than 1 μm, a sufficient color density may not be obtained. Further, when the thickness of each of the first layer 421, the second layer 422, and the third layer 423 exceeds 20 μm, the heat utilization amount of each of the first layer 421, the second layer 422 and the third layer 423 increases, and a color-developing property may deteriorate.

Further, the first layer 421, the second layer 422, and the third layer 423 may contain various additives such as a sensitizer and an ultraviolet absorber in addition to the above-mentioned materials, similarly to the above-mentioned recording layer 12.

The heat insulating layer 424 insulates between the first layer 421 and the second layer 422. The heat insulating layer 425 insulates between the second layer 422 and the third layer 423. The heat insulating layer 424 and the heat insulating layer 425 have transparency. Specifically, for example, the heat insulating layer 424 and the heat insulating layer 425 have transparency in the near infrared region and the visible region.

The heat insulating layer 424 and the heat insulating layer 425 contain, for example, a polymer material having general translucency. Examples of the specific material of the heat insulating layer 424 and the heat insulating layer 425 include at least one selected from the group consisting of polyvinyl chloride, polyvinyl acetate, vinyl chloride-vinyl acetate copolymer, ethyl cellulose, polystyrene, styrene-based copolymer, phenoxy resin, polyester, aromatic polyester, polyurethane, polycarbonate, polyacrylic acid ester, polymethacrylic acid ester, acrylic acid-based copolymer, maleic acid-based polymer, polyvinyl alcohol, modified polyvinyl alcohol, hydroxyethyl cellulose, carboxymethyl cellulose, starch, and the like. The heat insulating layer 424 and the heat insulating layer 425 may contain various additives such as an ultraviolet absorber.

The heat insulating layer 424 and the heat insulating layer 425 may contain an inorganic material having translucency. For example, when the heat insulating layer 424 and the heat insulating layer 425 contain porous silica, alumina, titania, carbon, or a complex thereof, a thermal conductivity becomes low and a heat insulating effect becomes high, which is preferable. The heat insulating layer 424 and the heat insulating layer 425 can be formed by, for example, a sol-gel method.

The thickness of each of the heat insulating layer 424 and the heat insulating layer 425 is preferably, for example, 3 μm or more and 100 μm or less, and more preferably 5 μm or more and 50 μm or less. The reason for the above limitation is that if the thickness of each of the heat insulating layer 424 and the heat insulating layer 425 is too thin, a sufficient heat insulating effect cannot be obtained, and if the thickness is too thick, the thermal conductivity deteriorates or the translucency decreases when the entire recording layer 42 is uniformly heated.

The first layer 421, the second layer 422, and the third layer 423 are the same as the recording layer 12 of the first embodiment except for the above.

### [Principle of Multicolor Display]

A principle of the multicolor display is explained with a case where the first layer 421, the second layer 422, and the third layer 423 contain a dye that develops a yellow color, a dye that develops a cyan color, and a dye that develops a magenta color, respectively, as an example.

For example, a color-developing portion developed in a green color is formed at a portion where the color-developing portion 421A developed in a yellow color, the color-developing portion 422A developed in a cyan color, and the non-color-developing portion 423B overlap each other in a thickness direction of the recording layer 42. For example, a color-developing portion developed in a red color is formed at a portion where the color-developing portion 421A developed in a yellow color, the non-color-developing portion 422B, and the color-developing portion 422A developed in a magenta color overlap each other in a thickness direction of the recording layer 42.

[Operational Effect]As described above, the recording medium 40 according to the fourth embodiment includes the first layer 421, the second layer 422, and the third layer 423. The first layer 421, the second layer 422, and the third layer 423 contain dyes exhibiting different colors, and an image is formed by the dyes contained in these layers. As a result, it is possible to display a multicolor (for example, full color) image.

Further, the pitch Δd′_{X} between the color-developing portions 421A, the color-developing portions 422A, and the color-developing portions 423A in the X-axis direction and the width W_{X} of each of the color-developing portions 421A, each of the color-developing portions 422A, and each of the color-developing portions 423A in the X-axis direction satisfy the relationship of Δd′_{X}>W_{X}. As a result, even if the first surface S1 of the structure 13 is a convex curved surface such as an arch, it is possible to prevent the color-developing portions 421A, the color-developing portions 422A, and the color-developing portions 423A adjacent to each other in the X-axis direction from overlapping each other. Therefore, even if the first surface S1 of the structure 13 is a convex curved surface such as an arch, it is possible to prevent a color density from deviating from a desired color density.

Further, as described above, since the pitch Δd′_{X} and the width W_{X} satisfy the relationship of Δd′_{X}>W_{X}, even if the first surface S1 of the structure 13 is a convex curved surface such as an arch, it is possible to prevent at least two of the color-developing portion 421A, the color-developing portion 422A, and the color-developing portion 423A from unintentionally overlapping each other in the thickness direction of the recording layer 42 (the Z-axis direction). Therefore, even if the first surface S1 of the structure 13 is a convex curved surface such as an arch, it is possible to prevent a color density from deviating from a desired hue.

FIG. 8B is a cross-sectional view showing a configuration of a recording layer 43 as a reference example. In the recording layer 43, the pitch Δd′_{X} and the width W_{X} do not satisfy the relationship of Δd′_{X}>W_{X}, and thus the color-developing portion 421A, the color-developing portion 422A, and the color-developing portion 423A unintentionally overlap each other in the thickness direction of the recording layer 42 (the Z-axis direction) (see a portion indicated by a region R1 in FIG. 8B). In such a portion where the color-developing portion 421A, the color-developing portion 422A, and the color-developing portion 423A overlap each other, a deviation from the desired hue occurs. As shown as a region R2 and a region R3 in FIG. 8B, in a case where two of the color-developing portion 421A, the color-developing portion 422A, and the color-developing portion 423A unintentionally overlap each other in the thickness direction of the recording layer 42 (the Z-axis direction), a deviation from the desired hue occurs.

### 5 Fifth Embodiment

### [Configuration of Recording Medium]

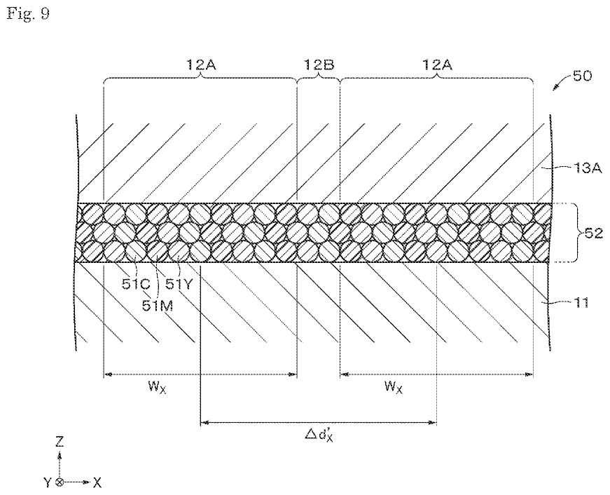

FIG. 9 is a cross-sectional view showing an example of a configuration of a recording medium 50 according to a fifth embodiment. The recording medium 50 is different from the recording medium 40 according to the fourth embodiment in that it includes a recording layer 52 having a single layer structure that displays a multicolor (for example, full color) image instead of the recording layer 42 having a three layer structure (see FIG. 8) that displays a multicolor (for example, full color) image.

The recording layer 52 contains three types of microcapsules 51C, 51M, and 51Y having different color-developing hues and a polymer resin. An image is formed by these three types of microcapsules 51C, 51M, and 51Y. The microcapsules 51C, 51M, and 51Y include, for example, color-exhibiting compounds that exhibit different colors (for example, a cyan color (C), a magenta color (M), and a yellow color (Y)), electron-accepting substances corresponding to the color-exhibiting compounds, photothermal conversion materials that absorb light rays in different wavelength ranges and generate heat, and a capsule wall. The color-exhibiting compounds, the electron-accepting substances, and the photothermal conversion materials are accommodated within the capsule wall. As a material of the capsule wall, for example, the material constituting the heat insulating layer 424 and the heat insulating layer 425 of the fourth embodiment is preferably used.

The recording layer 52 is the same as the recording layer 12 of the first embodiment except for the above.

### [Operational Effect]

As described above, in the recording medium 50 according to the fifth embodiment, the recording layer 52 contains the three types of microcapsules 51C, 51M, and 51Y exhibiting different colors in a color-developed state and the polymer resin. An image is formed by these three types of microcapsules 51C, 51M, and 51Y (specifically, the color-exhibiting compounds contained in these three types of microcapsules 51C, 51M, and 51Y). As a result, it is possible to display a multicolor (for example, full color) image on the recording layer 52 having a single layer structure.

### 6 Modification Example

### Modification Example 1

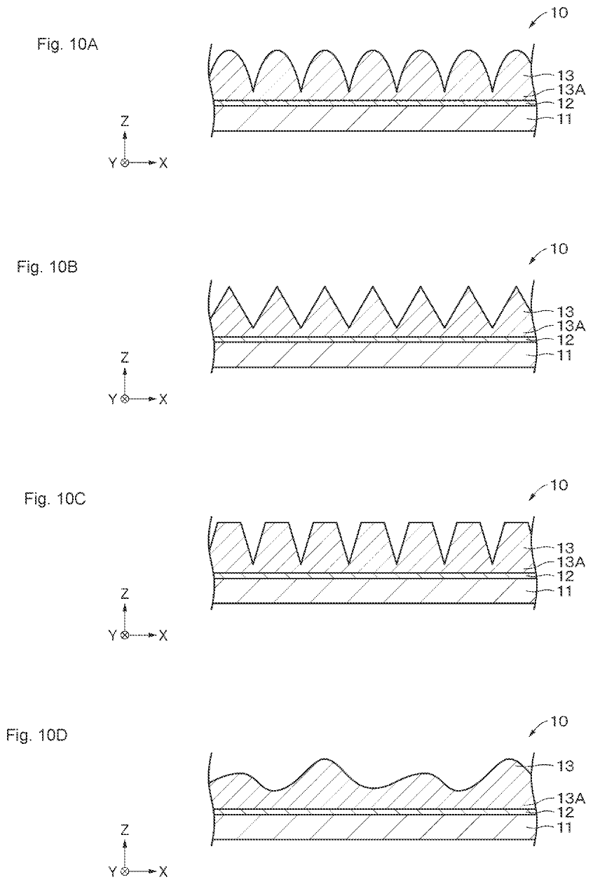

In the first and second embodiments, examples in which the cut surfaces of the structures 13 and 23 perpendicular to the X-axis direction (that is, the ridgeline direction of the structures 13 and 23) have substantially a fan shape and a substantially right triangular shape have been described, but the shapes of the cut surfaces of the structures 13 and 23 are not limited to these. For example, the shapes of the cut surfaces of the structures 13 and 23 may be a substantially parabolic shape (see FIG. 10A), a regular triangular shape (see FIG. 10B), an isosceles triangular shape, a trapezoidal shape (see FIG. 10C), and a wavy shape (see FIG. 10D), substantially an arc shape, substantially an elliptical arc shape, or the like.

There are portions such as the ridgelines of the structures 13 and 23 on which the laser light is incident at a right angle without being refracted. In that case, it may be difficult for the portions not to intersect with the adjacent drawing lines, but it can be determined that the visibility is hardly affected because the portions are covered with the ridgelines of the structures 13 and 23 themselves.

### Modification Example 2

In the third embodiment, an example in which the two-dimensionally arranged structures 33 each have a substantially hemispherical shape has been described, but the shape of the structure 33 is not limited to this. For example, the structure 33 may have a conical shape, a columnar shape, a needle shape, a semi-elliptical shape, a polygonal shape, or the like. Examples of the conical shape include, for example, a conical shape having a sharp top portion, a conical shape having a flat top portion, and a conical shape having a convex or concave curved surface at a top portion, but are not limited to these shapes. Examples of the conical shape having a convex curved surface at a top portion include a quadric curved surface shape such as a paraboloid shape. Further, a conical surface of the conical shape may be curved in a concave or convex shape. Examples of the polygonal shape include a cube shape and a rectangular parallelepiped shape. Further, the structure may be a two-dimensionally regular pattern (for example, a geometric pattern) or the like, or may be a two-dimensionally random pattern. There is a portion such as a vertex of the structure 33 on which the laser light is incident at a right angle without being refracted. In that case, it may be difficult for the portion not to intersect with the adjacent drawing lines, but it can be determined that the visibility is hardly affected because the portion is covered with the vortex of the structure 33 itself.

### Modification Example 3

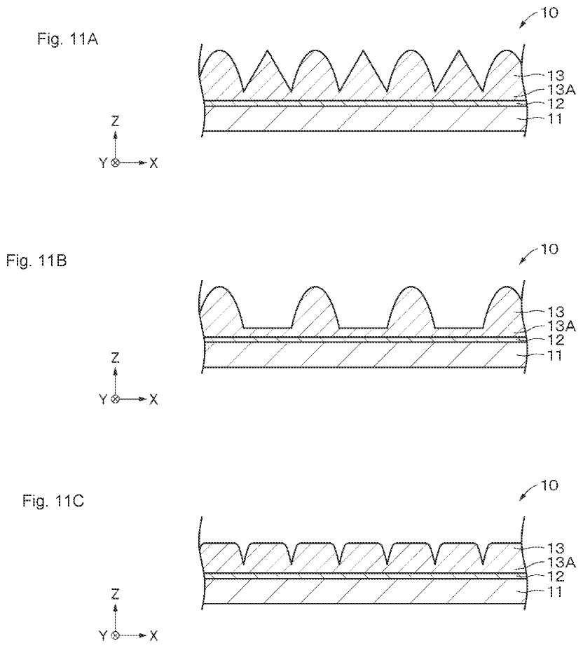

In the first to fifth embodiments, examples in which the structures 13, 23, and 33 having the same shape are one-dimensionally or two-dimensionally arranged have been described, but the shapes of the one-dimensionally or two-dimensionally arranged structures 13, 23, and 33 are not limited to one type. For example, as shown in FIG. 11A, two or more types of the structures 13, 23, and 33 having different shapes may be one-dimensionally or two-dimensionally arranged.

### Modification Example 4

In the first to fifth embodiments, examples in which the arrangement of the plurality of structures 13, 23, and 33 is regular have been described, but the arrangement of the plurality of structures 13, 23, 33 may be random.

### Modification Example 5

In the first to fifth embodiments, examples in which spaces are not provided between the adjacent structures 13, 23, and 33 and the structures are densely arranged have been described, but, as shown in FIG. 11B, spaces may be provided between the adjacent structures 13, 23, and 33.

### Modification Example 6

In the first and second embodiments, examples in which the ridgeline portions and the corner portions of the structures 13 and 23 are sharp have been described, but the ridgeline portions and the corner portions may have an R shape (roundness). For example, as shown in FIG. 11C, the shape of the cut surface of the structures 13 and 23 may be a shape in which the trapezoid corner portion has an R shape (roundness).

### Modification Example 7

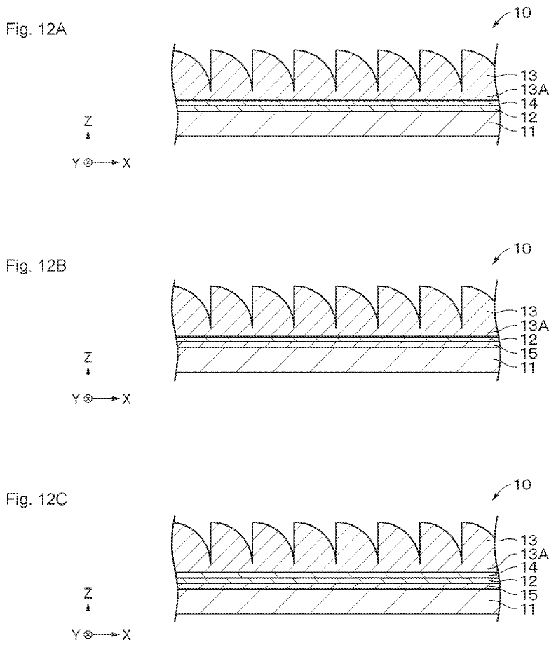

In the first embodiment, an example in which the structure 13 or the intermediate layer 13A is directly provided on the recording layer 12 has been described, but, as shown in FIG. 12A, the adhesion layer 14 may be provided between the recording layer 12 and the structure 13 or the intermediate layer 13A. In the present description, pressure sensitive adhesion is defined as a type of adhesion. According to this definition, the pressure sensitive adhesion layer is considered to be a type of the adhesion layer 14.

Similarly, in the second to fifth embodiments, the adhesion layer 14 may be provided between the recording layers 12, 22, 32, 42, and 52 and the structures 13, 23, and 33.

### Modification Example 8

In the first embodiment, an example in which the recording layer 12 is directly provided on the support substrate 11 has been described, but, as shown in FIG. 12B, the adhesion layer 15 may be provided between the support substrate 11 and the recording layer 12. In this case, as shown in FIG. 12C, the adhesion layer 14 may be further provided between the recording layer 12 and the structure 13 or the intermediate layer 13A.

Similarly, in the second to fifth embodiments, the adhesion layer 15 may be provided between the support substrate 11 and the recording layers 12, 22, 32, 42, and 52. In this case, the adhesion layer 14 may be further provided between the recording layers 12, 22, 32, 42, and 52 and the structures 13, 23, and 33.

### Modification Example 9

In the first to fifth embodiments, examples in which the recording mediums 10, 20, 30, 40, and 50 include the support substrate 11 have been described, but, in a case where the structures 13, 23, and 33 or the intermediate layer 13A is configured to be capable of supporting the recording layers 12, 22, 32, 42, and 52, the support substrate 11 may not be provided.

### Modification Example 10

In the fourth embodiment, an example in which the recording layer 42 includes three layers of the first to third layers 421 to 423 containing color-exhibiting compounds having different color-developing hues has been described, but the recording layer 42 may include a first layer to an n-th layer (where n is an integer of 2 or more) containing color-exhibiting compounds having different color-developing hues. In this case, each of the first layer to the n-th layer may have a plurality of color-developing portions. Further, a heat insulating layer may be provided between the first layer to the n-th layer.

### 7 Application Example

Next, application examples of the recording mediums 10, 20, 30, 40, and 50 (hereinafter referred to as “the recording medium 10 and the like”) described in the first to fifth embodiments and the modification examples will be described. Here, the application examples, which will be described below, are just an example, and the configuration thereof can be changed as appropriate. The recording medium 10 and the like can be applied to a part of each of various electronic devices or accessories, for example, a part of an accessory such as a watch (a wrist watch) as a so-called wearable terminal, a bag, clothes, a hat, glasses, and shoes, and the type of electronic device or the like is not particularly limited. Further, the present disclosure is not limited to the electronic devices and the accessories and can be applied to, for example, an interior and an exterior such as a wall of a building, an exterior of furniture such as a desk, and the like as the exterior member.

### Specific Example 1

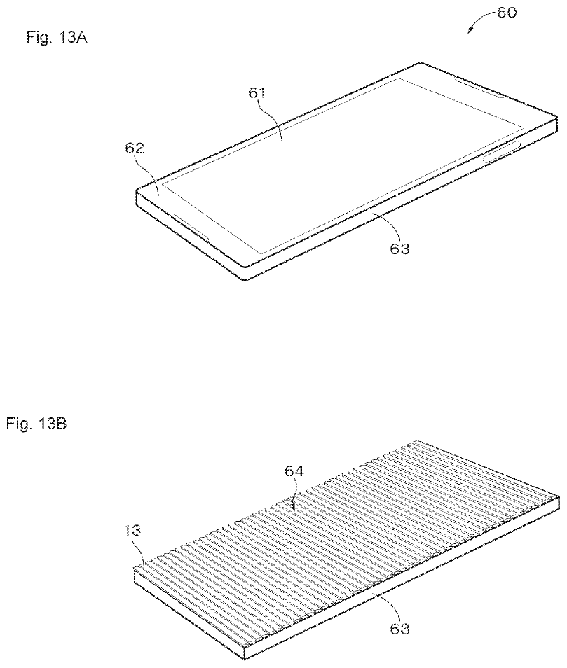

FIG. 13A shows an external configuration of a front surface of a smartphone 60, and FIG. 13B shows an external configuration of a back surface of the smartphone 60 shown in FIG. 13A. The smartphone 60 includes, for example, a display portion 61, a non-display portion 62, and a housing 63. For example, one surface of the housing 63 on the back surface side is provided with, for example, a recording medium 64 as an exterior member of the housing 63, and thus various color patterns can be displayed. The recording medium 64 is one of the recording medium 10 and the like. Two or more types of the recording medium 10 and the like may be used in combination. FIG. 13B shows an example in which the recording medium 10 (see FIG. 1) is used as the recording medium 64. Although the smartphone 60 is taken as an example here, the present disclosure is not limited to this and can also be applied to, for example, a notebook personal computer (PC), a tablet PC, or the like.

When an image is drawn on the recording medium 64, the recording layer 12 is irradiated with laser light via the structure 13.

### Specific Example 2

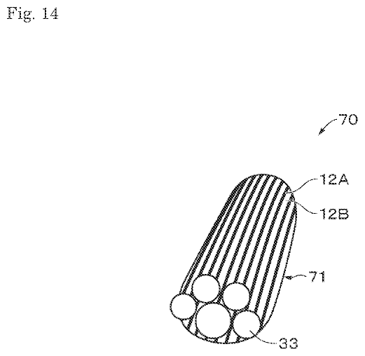

FIG. 14 is a perspective view showing an example of an appearance of a nail tip 70. The nail tip 70 is an example of the exterior member. The nail tip 70 includes a recording medium 71. The recording medium 71 is the same as the recording medium 30 of the third embodiment except that it has a curved surface shape and a plurality of structures 33 are provided on a part of a region of the recording layer 32. Although the description is omitted in FIG. 14, a color-developing portion 12A having a stripe shape or the like is also formed under the structure 33.

The structure 33 shown in FIG. 14 is an example, and the shape, the size, the arrangement, the arrangement region, and the like of the structures 33 can be changed according to the design of the nail tip 70. Similarly, the shapes, the sizes, the arrangement, the arrangement region, and the like of the color-developing portion 12A and the non-color-developing portion 12B can also be changed according to the design of the nail tip 70.

When an image is drawn on the recording medium 71, the recording layer 32 is irradiated with laser light via the structure 33.

### Specific Example 3

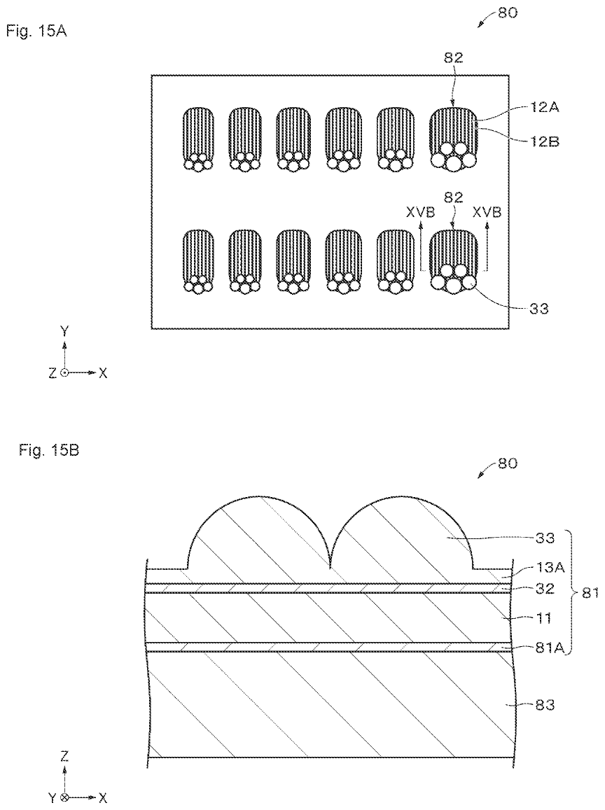

FIG. 15A is a plan view showing an example of an appearance of a nail seal 80. FIG. 15B is a cross-sectional view along line XVB-XVB of FIG. 15A. The nail seal 80 is an example of the exterior member. The nail seal 80 includes a peeling sheet 83 and a recording medium 81. The recording medium 81 is provided with a pressure sensitive adhesion layer 81A on the back surface of the support substrate 11. The recording medium 81 has a plurality of nail seal portions 82 that are attached to the nails of fingers of both hands. The nail seal portions 82 are held in a cut or semi-cut state with respect to the nail seal 80 and are configured to be peelable at an interface between the pressure sensitive adhesion layer 81A and the peeling sheet 83. The structure 33 is provided in a region of a part of the nail seal portion 82. Although the description is omitted in FIG. 15A, a color-developing portion 12A having a stripe shape or the like is also formed under the structure 33. The recording medium 81 is the same as the recording medium 30 of the third embodiment except for the above.

When an image is drawn on the recording medium 81, the recording layer 32 is irradiated with laser light via the structure 33.

The structure 33 shown in FIGS. 15A and 15B is an example, and the shape, the size, the arrangement, the arrangement region, and the like of the structures 33 can be changed according to the design of the nail seal 80. Similarly, the shapes, the sizes, the arrangement, the arrangement region, and the like of the color-developing portion 12A and the non-color-developing portion 12B can also be changed according to the design of the nail seal 80.

In the specific examples 2 and 3, examples in which the present disclosure is applied to the nail tip 70 and the nail seal 80 have been described, but the application examples of the present disclosure to nails are not limited to these. For example, after the recording layer 43 and the structure 33 are directly stacked on the nails of the human body, the recording layer 32 may be irradiated with laser light via the structure 33 to draw an image on the recording layer 32. Further, in the specific examples 2 and 3, the recording layer 42 or the recording layer 52 may be provided instead of the recording layer 32.

While embodiments and modification examples of the present disclosure have been described above in detail, the present disclosure is not limited to the above embodiments and modification examples, and various modifications based on the technical idea of the present disclosure can be made.

For example, the configurations, methods, processes, shapes, materials, numerical values, and the like exemplified in the above embodiments and modification examples are only examples, and as necessary, different configurations, methods, processes, shapes, materials, numerical values, and the like may be used. The configurations, methods, processes, shapes, materials, numerical values, and the like of the above embodiments and modification examples can be combined with each other as long as they do not deviate from the gist of the present disclosure.

In the numerical ranges stated in stages in the above embodiments and modification examples, the upper limit value or the lower limit value of the numerical range of a certain stage may be replaced with the upper limit value or the lower limit value in the numerical range of another stage. Unless otherwise specified, the materials exemplified in the above embodiments and modification examples may be used alone or two or more thereof may be used in combination.

In addition, the present disclosure may have the following configurations.

(1)

A recording medium including:
a recording layer configured to be able to change a color-developed state by an external stimulus; and
a plurality of structures provided on the recording layer,
wherein the recording layer has a plurality of color-developing portions, and wherein a pitch Δd′ between the color-developing portions and a width W of each of the color-developing portions satisfy a relationship of Δd′>W.
   (2)

The recording medium according to (1), wherein the pitch Δd′ between the color-developing portions changes in an in-plane direction of the recording layer.

(3)

The recording medium according to (1) or (2), wherein, in a case where light incident at a position P on a surface of the structure in a direction perpendicular to the recording layer reaches a position P′ of the color-developing portion, the pitch Δd′ between the color-developing portions at the position P′ becomes narrower as an inclination of the surface of the structure at the position P becomes steeper.

(4)

The recording medium according to any one of (1) to (3), wherein the external stimulus is laser light.

(5)

The recording medium according to any one of (1) to (4), wherein the recording layer includes
a color-exhibiting compound having an electron-donating property,
an electron-accepting substance, and
a photothermal conversion material.
   (6)

The recording medium according to any one of (1) to (5), wherein a ratio (A/W) of a width A of each of the structures to the width W of each of the color-developing portions is 1 or more and 10000 or less.

(7)

The recording medium according to any one of (1) to (6), wherein a width A of each of the structures is 0.1 mm or more and 10000 mm or less.

(8)

The recording medium according to any one of (1) to (7), wherein a refractive index of the structure is 1.35 or more and 1.85 or less.

(9)

The recording medium according to any one of (1) to (8), further comprising an adhesion layer provided between the recording layer and the plurality of structures.

(10)

The recording medium according to any one of (1) to (9), further including a support substrate,
wherein the recording layer is provided on the support substrate.
   (11)

The recording medium according to (10), further including an adhesion layer provided between the support substrate and the recording layer.

(12)

The recording medium according to any one of (1) to (11), wherein the structure has a curved surface.

(13)

The recording medium according to (1),
wherein the structure is a columnar body extending in a first direction in a plane of the recording layer, and
wherein a cut surface generated when the structure is cut in a second direction perpendicular to the first direction has a substantially right triangular shape.
   (14)

The recording medium according to any one of (1) to (13), wherein the plurality of structures are one-dimensionally arranged.

(15)

The recording medium according to any one of (1) to (12), wherein the plurality of structures are two-dimensionally arranged.

(16)

The recording medium according to any one of (1) to (15),
wherein the recording layer includes a first layer to an n-th layer (where n is an integer of 2 or more) containing color-exhibiting compounds having different color-developing hues, and
wherein the first layer to the n-th layer have a plurality of the color-developing portions.
   (17)

The recording medium according to any one of (1) to (15),
wherein the recording layer includes a first layer, a second layer, and a third layer,
wherein the first layer, the second layer, and the third layer contain color-exhibiting compounds having different color-developing hues, and
wherein the first layer, the second layer, and the third layer have a plurality of the color-developing portions.
   (18)

The recording medium according to any one of (1) to (15), wherein the recording layer contains three types of microcapsules having different color-developing hues.

(19)

A recording medium including:
a recording layer configured to be able to change a color-developed state by an external stimulus; and
a plurality of structures provided on the recording layer,
wherein the recording layer has a plurality of color-developing portions, and
wherein a pitch Δd′ between the color-developing portions changes in an in-plane direction of the recording layer.
   (20)

An exterior member including the recording medium according to any one of (1) to (19).

### REFERENCE SIGNS LIST

10, 20, 30, 40, 50, 64, 71, 81 Recording medium
11 Support substrate
12, 22, 32, 42, 43 Recording layer
12A, 421A, 422A, 423A Color-developing portion
12B, 421B, 422B, 423B Non-color-developing portion
13, 23, 33 Structure
13A Intermediate layer
14, 15 Adhesion layer
51C, 51M, 51Y Microcapsule
424, 425 Heat insulating layer
60 Smartphone
61 Display portion
62 Non-display portion
63 Housing
70 Nail tip
80 Nail seal
82 Nail seal portion
81A Pressure sensitive adhesion layer
83 Peeling sheet

1. A recording medium comprising:
a recording layer configured to be able to change a color-developed state by an external stimulus; and
a plurality of structures provided on the recording layer,
wherein the recording layer has a plurality of color-developing portions, and
wherein a pitch Δd′ between the color-developing portions and a width W of each of the color-developing portions satisfy a relationship of Δd′>W.

2. The recording medium according to claim 1, wherein the pitch Δd′ between the color-developing portions changes in an in-plane direction of the recording layer.

3. The recording medium according to claim 1, wherein, in a case where light incident at a position P on a surface of the structure in a direction perpendicular to the recording layer reaches a position P′ of the color-developing portion, the pitch Δd′ between the color-developing portions at the position P′ becomes narrower as an inclination of the surface of the structure at the position P becomes steeper.

4. The recording medium according to claim 1, wherein the external stimulus is laser light.

5. The recording medium according to claim 1, wherein the recording layer includes
a color-exhibiting compound having an electron-donating property,
an electron-accepting substance, and
a photothermal conversion material.

6. The recording medium according to claim 1, wherein a ratio (A/W) of a width A of each of the structures to the width W of each of the color-developing portions is 1 or more and 10000 or less.

7. The recording medium according to claim 1, wherein a width A of each of the structures is 0.1 mm or more and 10000 mm or less.

8. The recording medium according to claim 1, wherein a refractive index of the structure is 1.35 or more and 1.85 or less.

9. The recording medium according to claim 1, further comprising an adhesion layer provided between the recording layer and the plurality of structures.

10. The recording medium according to claim 1, further comprising a support substrate,
wherein the recording layer is provided on the support substrate.

11. The recording medium according to claim 10, further comprising an adhesion layer provided between the support substrate and the recording layer.

12. The recording medium according to claim 1, wherein the structure has a curved surface.

13. The recording medium according to claim 1,
wherein the structure is a columnar body extending in a first direction in a plane of the recording layer, and
wherein a cut surface generated when the structure is cut in a second direction perpendicular to the first direction has a substantially right-triangular shape.

14. The recording medium according to claim 1, wherein the plurality of structures are one-dimensionally arranged.

15. The recording medium according to claim 1, wherein the plurality of structures are two-dimensionally arranged.

16. The recording medium according to claim 1,
wherein the recording layer includes a first layer to an n-th layer (where n is an integer of 2 or more) containing color-exhibiting compounds having different color-developing hues, and
wherein the first layer to the n-th layer have a plurality of the color-developing portions.

17. The recording medium according to claim 1,
wherein the recording layer includes a first layer, a second layer, and a third layer,
wherein the first layer, the second layer, and the third layer contain color-exhibiting compounds having different color-developing hues, and
wherein the first layer, the second layer, and the third layer have a plurality of the color-developing portions.

18. The recording medium according to claim 1, wherein the recording layer contains three types of microcapsules having different color-developing hues.

19. A recording medium comprising:
a recording layer configured to be able to change a color-developed state by an external stimulus; and
a plurality of structures provided on the recording layer,
wherein the recording layer has a plurality of color-developing portions, and
wherein a pitch Δd′ between the color-developing portions changes in an in-plane direction of the recording layer.

20. An exterior member comprising the recording medium according to claim 1.
